(19) United States
(12) Patent Application Publication
(10) Pub. No.: US 2023/0344021 A1
(43) Pub. Date: Oct. 26, 2023

(54) UNDER-VOLTAGE PROTECTION METHOD AND BATTERY MANAGEMENT SYSTEM APPLYING THE SAME

(71) Applicant: Cheng Uei Precision Industry Co., Ltd., New Taipei City (TW)

(72) Inventors: Ti Wu, New Taipei City (TW); Chin Huang Tseng, New Taipei City (TW)

(21) Appl. No.: 18/072,620

(22) Filed: Nov. 30, 2022

(30) Foreign Application Priority Data
Apr. 26, 2022 (CN) 202210442958.0

(51) Int. Cl. H01M 10/42; H01M 10/44; H02J 7/00

(52) U.S. Cl. CPC H01M 10/425; H01M 10/44; H02J 7/0036; H01M 2010/4271; H01M 2010/4278

(57) ABSTRACT

An under-voltage protection method is applied in a battery management system. The battery management system includes a control module, an analog front-end unit, a monitoring unit, and a charging and discharging unit. The control module has a system communication function. The control module includes a micro-controller, and an electrically erasable programmable read-only memory connected with the micro-controller. The analog front-end unit is connected to the micro-controller. The monitoring unit is connected to the analog front-end unit. The charging and discharging unit includes a charging switch which is a charging field effect transistor, and a discharging switch which is a discharging field effect transistor. The monitoring unit, and the charging and discharging unit are connected with the analog front-end unit.

### CROSS-REFERENCE TO RELATED APPLICATION

The present application is based on, and claims priority from, China Patent Application No. 202210442958.0, filed Apr. 26, 2022, the disclosure of which is hereby incorporated by reference herein in its entirety.

### BACKGROUND OF THE INVENTION

### 1. Field of the Invention

The present invention generally relates to an under-voltage protection method, and more particularly to an under-voltage protection method which is able to maintain that a battery module is charged and discharged normally.

### 2. The Related Art

In a conventional under-voltage protection product, such as a vehicle battery module, when a battery management system is initialized, a control unit will set a under-voltage protection threshold of an analog front-end unit (AFE). When an under-voltage protection of a battery module is happened, namely when a voltage of the battery module is lower than the under-voltage protection threshold, the battery management system will shut down a charging unit and a discharging unit, and the control unit will start a shutdown protection to shut down the battery management system to protect the battery module after a few seconds. When the battery management system is switched on again and the under voltage state of the battery module is still happening, a whole under-voltage protection action is repeated, the battery management system forms a circulation that is switched between a boot-up status once again, and a shutdown status on account of the under-voltage protection of the battery module, so the conventional under-voltage protection product has no way of detecting a charger, and the conventional under-voltage protection product is unable to be charged.

Therefore, it is necessary to provide an under-voltage protection method which is able to maintain that a battery module is charged and discharged normally, after the battery management system shuts down due to an under-voltage protection, the battery management system is able to be started again for proceeding with a charging function.

### SUMMARY OF THE INVENTION

An object of the present invention is to provide an under-voltage protection method which is able to maintain that a battery cell is charged and discharged normally. The under-voltage protection method is applied in a battery management system. The battery management system includes a control module, an analog front-end unit, a monitoring unit, and a charging and discharging unit. The control module is connected to the analog front-end unit. The monitoring unit, and the charging and discharging unit are both connected with the analog front-end unit. Specific steps of the under-voltage protection method are described hereinafter. Write an instruction of an under-voltage protection to the analog front-end unit by a micro-controller of the control module. The under-voltage protection has a first section under-voltage protection and a second section under-voltage protection. Stop the second section under-voltage protection by the analog front-end unit. Confirm whether a previous shutdown cause of the battery management system is an under-voltage protection shutdown by the micro-controller. The micro-controller reads an electrically erasable programmable read-only memory in advance to check whether the previous shutdown cause of the battery management system is the under-voltage protection shutdown, if the previous shutdown cause of the battery management system is without being the under-voltage protection shutdown, proceed with a next step of activating the second section under-voltage protection by the analog front-end unit, if the previous shutdown cause of the battery management system is the under-voltage protection shutdown, proceed with a step of judging whether voltage values of various series of the battery cells reach a relieving threshold of the under-voltage protection. Activate the second section under-voltage protection by the analog front-end unit. Judge whether the voltage values of various series of the battery cells reach the relieving threshold of the under-voltage protection by the monitoring unit, if the voltage values of the various series of the batteries reach the relieving threshold of the under-voltage protection, proceed with a step of activating the second section under-voltage protection by the analog front-end unit, if the voltage values of the various series of the battery cells are lower than the relieving threshold of the under-voltage protection, the voltage values of the various series of the battery cells are in inconformity with the relieving threshold of the under-voltage protection, proceed with a step of confirming whether a charger is connected with the battery management system by the analog front-end unit. Check whether the charger is connected, if the charger is connected for a few seconds, proceed with a step of entering a charging mode through the charging and discharging unit, and if the charger is disconnected for predetermined time, proceed with a next step. Write a battery status to an electrically erasable programmable read-only memory, and then shut down. Enter a charging mode through a charging and discharging unit.

Another object of the present invention is to provide an under-voltage protection method applied in a battery management system. The battery management system includes a control module, an analog front-end unit, a monitoring unit, and a charging and discharging unit. The control module is connected to the analog front-end unit. The monitoring unit, and the charging and discharging unit are connected with the analog front-end unit. Specific steps of the under-voltage protection method are described hereinafter. Write an instruction of an under-voltage protection to the analog front-end unit by a micro-controller of the control module. The under-voltage protection has a first section under-voltage protection and a second section under-voltage protection. Stop the second section under-voltage protection by the analog front-end unit. Confirm whether a previous shutdown cause of the battery management system is an under-voltage protection shutdown by the micro-controller. The micro-controller reads an electrically erasable programmable read-only memory in advance to check whether the previous shutdown cause of the battery management system is the under-voltage protection shutdown, if the previous shutdown cause of the battery management system is without being the under-voltage protection shutdown, proceed with a next step of activating the second section under-voltage protection by the analog front-end unit, if the previous shutdown cause of the battery management system is the under-voltage protection shutdown, proceed with a step of judging whether a status of various series of the battery cells meets a relieving threshold of the under-voltage protection. Activate the second section under-voltage protection by the analog front-end unit. Confirm whether a charger is charged by the analog front-end unit. The micro-controller is communicated with the analog front-end unit to monitor a voltage of the battery management system. If the voltage of the battery management system is higher than a voltage protection threshold value of the under-voltage protection, the analog front-end unit checks whether the charger is connected, if the charger is connected, proceed with a step of entering a charging mode through the charging and discharging unit, if the charger is unconnected for few seconds, proceed with a step of writing a battery status to the electrically erasable programmable read-only memory, and then shut down. Judge whether a status of various series of the battery cells meets a relieving threshold of the under-voltage protection by the monitoring unit, if the status of the various series of the batteries meets the relieving threshold of the under-voltage protection, proceed with a step of activating the second section under-voltage protection by the analog front-end unit, if the status of the various series of the battery cells are in inconformity with the relieving threshold of the under-voltage protection, proceed with a step of confirming whether a charger is charged by the analog front-end unit. Check whether the charger is connected, if the charger is connected for a few seconds, proceed with a step of entering the charging mode through the charging and discharging unit, and if the charger is disconnected for predetermined time, proceed with a next step. Write the battery status to the electrically erasable programmable read-only memory, and then shut down. Enter a charging mode through a charging and discharging unit.

Another object of the present invention is to provide a battery management system. The battery management system includes a control module, an analog front-end unit, a monitoring unit, and a charging and discharging unit. The control module has a system communication function. The control module includes a micro-controller, and an electrically erasable programmable read-only memory connected with the micro-controller. The analog front-end unit is connected to the micro-controller. The analog front-end unit is used for proceeding a signal communication with the micro-controller. The monitoring unit is connected to the analog front-end unit. The monitoring unit is used for monitoring a voltage, a current and a temperature of the battery management system. The charging and discharging unit is for controlling and protecting the battery management system. The charging and discharging unit includes a charging switch which is a charging field effect transistor, and a discharging switch which is a discharging field effect transistor. The monitoring unit, and the charging and discharging unit are connected with the analog front-end unit. After the battery management system applying an under-voltage protection method enters an under-voltage protection, the battery management system is shut down, the battery management system is capable to be restarted, so the battery management system is recharged normally due to the under-voltage protection.

As described above, after the battery management system applying the under-voltage protection method enters the under-voltage protection (UVP), the battery management system is shut down, the battery management system is capable to be restarted, so the battery management system is recharged normally due to the under-voltage protection. As a result, the under-voltage protection method which is able to maintain that the battery cell is charged and discharged normally.

### BRIEF DESCRIPTION OF THE DRAWINGS

The present invention will be apparent to those skilled in the art by reading the following description, with reference to the attached drawings, in which:

FIG. 1 is a system block diagram of a battery management system in accordance with the present invention, wherein an under-voltage protection method is applied in the battery management system; and

FIG. 2 is a flow chart of the under-voltage protection method in accordance with the present invention.

### DETAILED DESCRIPTION OF THE PREFERRED EMBODIMENT

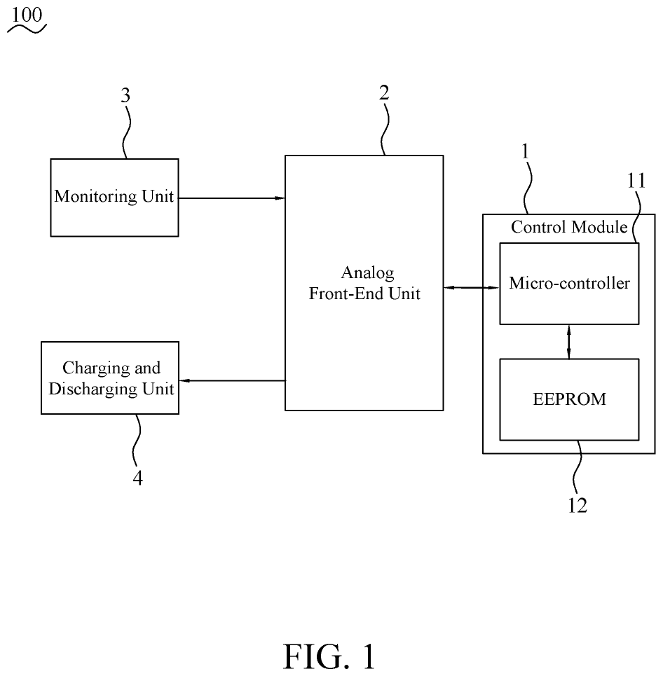

Referring to FIG. 1, an under-voltage protection method applied in a battery management system 100 in accordance with the present invention are shown. The under-voltage protection method is applied in the battery management system 100. The battery management system 100 includes a control module 1, an analog front-end unit 2 (AFE), a monitoring unit 3, and a charging and discharging unit 4. The control module 1 is connected to the analog front-end unit 2 (AFE). The monitoring unit 3 and the charging and discharging unit 4 are both connected with the analog front-end unit 2.

The control module 1 includes a micro-controller 11 and an electrically erasable programmable read-only memory 12 (EEPROM). The electrically erasable programmable read-only memory 12 is connected with the micro-controller 11. The control module 1 has a system communication function, calculating battery state of charge (SOC) and state of health (SOH) functions, a controlling external setting function and a recording data function.

The analog front-end unit 2 is connected to the micro-controller 11. The analog front-end unit 2 is used for proceeding a signal communication with the micro-controller 11.

The monitoring unit 3 is connected to the analog front-end unit 2. The monitoring unit 3 is used for monitoring a voltage, a current and a temperature of the battery management system 100.

The charging and discharging unit 4 includes a charging switch 41 which is a charging field effect transistor (CFET), and a discharging switch 42 which is a discharging field effect transistor (DFET). The charging and discharging unit 4 is used for controlling and protecting the battery management system 100.

The monitoring unit 3, and the charging and discharging unit 4 transmit monitoring and controlling signals to the analog front-end unit 2. The analog front-end unit 2 transmits the monitoring and controlling signals to the micro-controller 11, so the micro-controller 11 is able to control the battery management system 100.

The micro-controller 11 will write an instruction of an under-voltage protection (UVP) to the analog front-end unit 2 at the beginning. The under-voltage protection (UVP) has a first section under-voltage protection (UVP1) and a second section under-voltage protection (UVP2). The first section under-voltage protection (UVP1) and the second section under-voltage protection (UVP2) are used to protect a life of a battery cell. When a voltage value of the battery cell is too low, a chemical characteristic of the battery cell is affected, and then usage time of the battery cell is affected. The UVP1 is controlled by the micro-controller 11, and the UVP2 is controlled by the analog front-end unit 2. Each of the UVP1 and the UVP2 has a voltage protection threshold value. When the voltage of the battery management system 100 is lower than the voltage protection threshold value of the UVP, the UVP is activated. The voltage protection threshold value of the UVP2 is lower than the voltage protection threshold value of the UVP1. The UVP has delay time, the delay time of the UVP is used for delaying an activation of the UVP when the voltage of the battery management system 100 is lower than the voltage protection threshold value. The delay time for the UVP1 is longer than the delay time for the UVP2.

When the voltage of the battery management system 100 drops to the voltage protection threshold value of the UVP1, a timer is activated, and the delay time of the UVP1 starts to be calculated. If the voltage of the battery management system 100 is between the voltage protection threshold value of the UVP1 and the voltage protection threshold value of the UVP2, and the timer reaches the delay time of the UVP1, the battery management system 100 enters a UVP1 state, and the battery management system 100 is shut down. When the voltage of the battery management system 100 is lower than the voltage protection threshold value of the UVP2, the timer is activated, and the delay time of the UVP2 starts to be calculated. If the voltage of the battery management system 100 is kept below the voltage protection threshold value of the UVP2, and the timer reaches the delay time of the UVP2, the battery management system 100 enters a UVP2 state, and the battery management system 100 is shut down.

Furthermore, when the voltage of the battery management system 100 is lower than the voltage protection threshold value of the UVP1 or the voltage protection threshold value of the UVP2, the analog front-end unit 2 will give an alarm according to the predetermined delay time of the UVP1 or the UVP2. If duration time satisfies the predetermined delay time of the UVP1 or the UVP2, the signals are sent to the micro-controller 11 or the analog front-end unit 2. The micro-controller 11 writes the UVP1 state to the electrically erasable programmable read-only memory 12, or the analog front-end unit 2 writes the UVP2 state to the electrically erasable programmable read-only memory 12, and then the battery management system 100 is shut down.

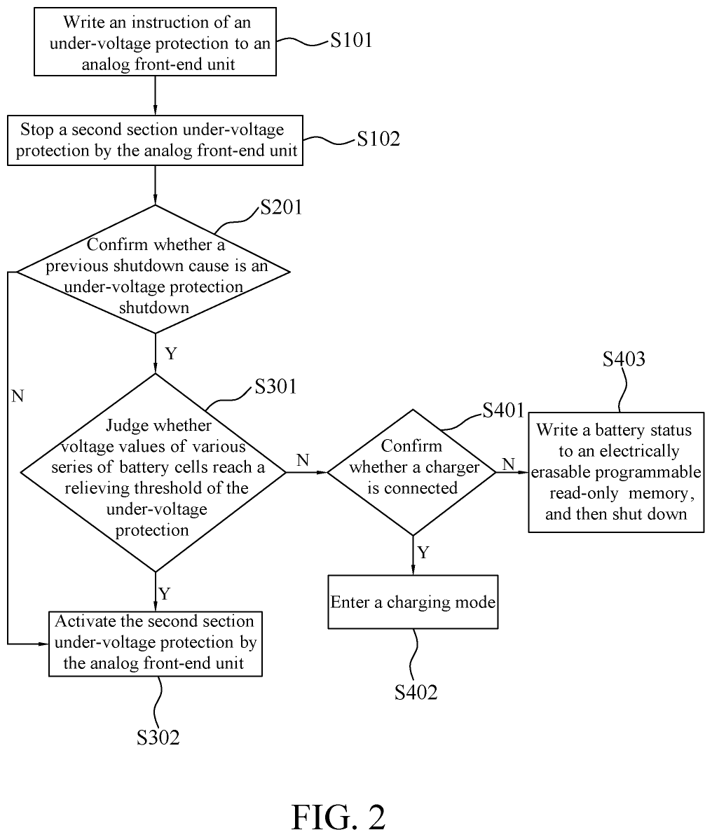

Referring to FIG. 1 and FIG. 2, when the battery management system 100 is activated, the under-voltage protection method of the battery management system 100 proceeds with following steps.

Step S101: write the instruction of the under-voltage protection (UVP) to the analog front-end unit 2 by the micro-controller 11 of the control module 1.

Step S102: stop the second section under-voltage protection (UVP2) by the analog front-end unit 2.

Step S201: confirm whether a previous shutdown cause of the battery management system 100 is an under-voltage protection shutdown by the micro-controller 11. The step S201 is that the micro-controller 11 reads the electrically erasable programmable read-only memory 12 in advance to check whether the previous shutdown cause of the battery management system 100 is the under-voltage protection shutdown. If the previous shutdown cause of the battery management system 100 is without being the under-voltage protection shutdown, proceed with a step S302 of activating the second section under-voltage protection by the analog front-end unit 2; if the previous shutdown cause of the battery management system 100 is the under-voltage protection shutdown, proceed with a step S301 of judging whether voltage values of various series of the battery cells reach a relieving threshold of the under-voltage protection.

Step S301: judge whether the voltage values of the various series of the battery cells reach the relieving threshold of the under-voltage protection (UVP) by the monitoring unit 3. If the voltage values of the various series of the batteries reach the relieving threshold of the under-voltage protection (UVP), proceed with the step S302 of activating the second section under-voltage protection (UVP2) by the analog front-end unit 2. If the voltage values of the various series of the battery cells are lower than the relieving threshold of the under-voltage protection (UVP), the voltage values of the various series of the battery cells are in inconformity with the relieving threshold of the under-voltage protection (UVP), proceed with a step S401 of confirming whether a charger is connected with the battery management system 100 by the analog front-end unit 2. Specifically, the first section under-voltage protection (UVP1) state is controlled by the micro-controller 11, and the second section under-voltage protection (UVP2) state is controlled by the analog front-end unit 2. The relieving threshold of the under-voltage protection (UVP) is higher than the voltage protection threshold value of the UVP2.

Step S302: activate the second section under-voltage protection (UVP2) by the analog front-end unit 2.

Step S401: confirm whether the charger is connected with the battery management system 100 by the analog front-end unit 2. Specifically, the analog front-end unit 2 confirms whether the charger is connected with the battery management system 100 in advance. The micro-controller 11 is communicated with the analog front-end unit 2 to monitor the voltage of the battery management system 100. If an electric quantity of the battery management system 100 approaches a full charge condition, the analog front-end unit 2 proceeds with the confirmation. If the voltage of the battery management system 100 is higher than a voltage protection threshold value of the under-voltage protection, the analog front-end unit 2 checks whether the charger is connected, if the charger is connected, proceed with a step S402 of entering the charging mode through the charging and discharging unit, if the charger is unconnected for the few seconds, proceed with a step S403 of writing a battery status to the electrically erasable programmable read-only memory 12, and then shut down. When the step S401 is proceeded, a few seconds are waited, in detail, ten seconds are waited.

Step S402: check whether the charger is connected, if the charger is connected for a few seconds, proceed with a step of entering a charging mode through the charging and discharging unit 4, and if the charger is disconnected for predetermined time, proceed with a next step. The battery management system 100 waits ten seconds in the step of checking whether the charger is connected. The charging and discharging unit 4 activates the charging mode. In the charging mode, the discharging field effect transistor (D-FET) switch is activated at first, and then the charging field effect transistor (C-FET) switch is activated.

Step S403: write the battery status to the electrically erasable programmable read-only memory 12, and then shut down.

As described above, after the battery management system 100 applying the under-voltage protection method enters the under-voltage protection (UVP), the battery management system 100 is shut down, the battery management system 100 is capable to be restarted, so the battery management system 100 is recharged normally due to the under-voltage protection. As a result, the under-voltage protection method which is able to maintain that the battery cell is charged and discharged normally.

What is claimed is:

1. An under-voltage protection method applied in a battery management system, the battery management system including a control module, an analog front-end unit, a monitoring unit, and a charging and discharging unit, the control module being connected to the analog front-end unit, the monitoring unit, and the charging and discharging unit being both connected with the analog front-end unit, the under-voltage protection method comprising steps of:
writing an instruction of an under-voltage protection to the analog front-end unit by a micro-controller of the control module, the under-voltage protection having a first section under-voltage protection and a second section under-voltage protection;
stopping the second section under-voltage protection by the analog front-end unit;
confirming whether a previous shutdown cause of the battery management system is an under-voltage protection shutdown by the micro-controller, the micro-controller reading an electrically erasable programmable read-only memory in advance to check whether the previous shutdown cause of the battery management system is the under-voltage protection shutdown, if the previous shutdown cause of the battery management system is without being the under-voltage protection shutdown, proceeding with a next step of activating the second section under-voltage protection by the analog front-end unit, if the previous shutdown cause of the battery management system is the under-voltage protection shutdown, proceeding with a step of judging whether voltage values of various series of the battery cells reach a relieving threshold of the under-voltage protection;
activating the second section under-voltage protection by the analog front-end unit;
judging whether the voltage values of various series of the battery cells reach the relieving threshold of the under-voltage protection by the monitoring unit, if the voltage values of the various series of the batteries reach the relieving threshold of the under-voltage protection, proceeding with a step of activating the second section under-voltage protection by the analog front-end unit, if the voltage values of the various series of the battery cells are lower than the relieving threshold of the under-voltage protection, the voltage values of the various series of the battery cells are in inconformity with the relieving threshold of the under-voltage protection, proceeding with a step of confirming whether a charger is connected with the battery management system by the analog front-end unit;
checking whether the charger is connected, if the charger is connected for a few seconds, proceeding with a step of entering a charging mode through the charging and discharging unit, and if the charger is disconnected for predetermined time, proceeding with a next step; and
writing a battery status to an electrically erasable programmable read-only memory, and then shutting down.

2. The under-voltage protection method as claimed in claim 1, wherein the battery management system waits ten seconds in the step of checking whether the charger is connected.

3. The under-voltage protection method as claimed in claim 1, wherein in the step of confirming whether the charger is connected with the battery management system by the analog front-end unit, the analog front-end unit confirms whether the charger is connected with the battery management system in advance, the micro-controller is communicated with the analog front-end unit to monitor a voltage of the battery management system, if an electric quantity of the battery management system approaches a full charge condition, the analog front-end unit proceeds with a confirmation.

4. The under-voltage protection method as claimed in claim 3, wherein if the voltage of the battery management system is higher than a voltage protection threshold value of the under-voltage protection, the analog front-end unit checks whether the charger is connected, if the charger is connected, proceed with a step of entering the charging mode through the charging and discharging unit, if the charger is unconnected for the few seconds, proceed with a step of writing the battery status to the electrically erasable programmable read-only memory, and then shut down.

5. The under-voltage protection method as claimed in claim 1, wherein in the step of entering the charging mode through the charging and discharging unit, the charging and discharging unit activates the charging mode, in the charging mode, a discharging field effect transistor switch is activated at first, and then the charging field effect transistor switch is activated.

6. An under-voltage protection method applied in a battery management system, the battery management system including a control module, an analog front-end unit, a monitoring unit, and a charging and discharging unit, the control module being connected to the analog front-end unit, the monitoring unit, and the charging and discharging unit being connected with the analog front-end unit, the under-voltage protection method comprising steps of:
writing an instruction of an under-voltage protection to the analog front-end unit by a micro-controller of the control module, the under-voltage protection having a first section under-voltage protection and a second section under-voltage protection;
stopping the second section under-voltage protection by the analog front-end unit;
confirming whether a previous shutdown cause of the battery management system is an under-voltage protection shutdown by the micro-controller, the micro-controller reading an electrically erasable programmable read-only memory in advance to check whether the previous shutdown cause of the battery management system is the under-voltage protection shutdown, if the previous shutdown cause of the battery management system is without being the under-voltage protection shutdown, proceeding with a next step of activating the second section under-voltage protection by the analog front-end unit, if the previous shutdown cause of the battery management system is the under-voltage protection shutdown, proceeding with a step of judging whether a status of various series of the battery cells meets a relieving threshold of the under-voltage protection;
activating the second section under-voltage protection by the analog front-end unit;
confirming whether a charger is charged by the analog front-end unit, the micro-controller being communicated with the analog front-end unit to monitor a voltage of the battery management system, if the voltage of the battery management system is higher than a voltage protection threshold value of the under-voltage protection, the analog front-end unit checking whether the charger is connected, if the charger is connected, proceeding with a step of entering a charging mode through the charging and discharging unit, if the charger is unconnected for few seconds, proceeding with a step of writing a battery status to the electrically erasable programmable read-only memory, and then shutting down;
judging whether a status of various series of the battery cells meets a relieving threshold of the under-voltage protection by the monitoring unit, if the status of the various series of the batteries meets the relieving threshold of the under-voltage protection, proceeding with a step of activating the second section under-voltage protection by the analog front-end unit, if the status of the various series of the battery cells are in inconformity with the relieving threshold of the under-voltage protection, proceeding with a step of confirming whether a charger is charged by the analog front-end unit;
checking whether the charger is connected, if the charger is connected for a few seconds, proceeding with a step of entering the charging mode through the charging and discharging unit, and if the charger is disconnected for predetermined time, proceeding with a next step; and
writing the battery status to the electrically erasable programmable read-only memory, and then shutting down.

7. A battery management system, comprising:
a control module having a system communication function, the control module including a micro-controller, and an electrically erasable programmable read-only memory connected with the micro-controller;
an analog front-end unit connected to the micro-controller, the analog front-end unit being used for proceeding a signal communication with the micro-controller;
a monitoring unit connected to the analog front-end unit, the monitoring unit being used for monitoring a voltage, a current and a temperature of the battery management system; and
a charging and discharging unit for controlling and protecting the battery management system, the charging and discharging unit including a charging switch which is a charging field effect transistor, and a discharging switch which is a discharging field effect transistor, the monitoring unit, and the charging and discharging unit being connected with the analog front-end unit,
wherein after the battery management system applying an under-voltage protection method enters an under-voltage protection, the battery management system is shut down, the battery management system is capable to be restarted, so the battery management system is recharged normally due to the under-voltage protection.
